(19) United States
(12) Patent Application Publication
(10) Pub. No.: US 2008/0029347 A1
(43) Pub. Date: Feb. 7, 2008

(54) Method and device for mounting a rope on a rope pulley

(76) Inventor: Osmo Bjorni, Hyvinkaa (FI)

Correspondence Address: HARNESS, DICKEY & PIERCE, P.L.C., P.O. BOX 8910, RESTON, VA, 20195, US

(21) Appl. No.: 11/826,735

(22) Filed: Jul. 18, 2007

Related U.S. Application Data
(63) Continuation of application No. PCT/FI06/00021, filed on Jan. 27, 2006.

(30) Foreign Application Priority Data
Jan. 28, 2005 (FI) 20050096

(51) Int. Cl. B66B 11/04

(52) U.S. Cl. 187/251

(57) ABSTRACT

The invention relates to a method and a device for mounting a rope 3 on a rope pulley (2) by winding the rope (3) at least partially around the rope pulley (2). According to the invention, the end of the rope (3) to be mounted is pressed into a rope groove of the rope pulley (2) by means of a special rope holder (4) attached to the rope pulley (2), and the rope (3) is guided over the rope pulley (2) by setting the rope pulley (2) into rotating motion.

### PRIORITY STATEMENT

This application is a continuation of PCT/FI2006/000021, filed on Jan. 27, 2006, which is an international application claiming priority from FI 20050096, filed Jan. 28, 2005, the entire contents of which are hereby incorporated by reference.

The present invention relates to a method as defined in the preamble of claim 1 and to device method as defined in the preamble of claim 6 for mounting a rope on a rope pulley.

New elevator solutions are increasingly frequently implemented using large suspension ratios, necessitating the use of a plurality of rope pulleys in the rigging. The rope suspension of a modern elevator may comprise as many as over 20 diverting pulleys. In addition, modern elevators often use thin high-strength ropes, a plurality of which may be placed side by side.

According to prior art, elevator hoisting ropes are mounted manually in the rope grooves of a diverting pulley by feeding ropes onto the diverting pulley and rotating the diverting pulley in the direction of rope feed. Jump guards or similar devices keep the ropes in the rope grooves. However, diverting pulleys are often placed in a casing, and consequently feeding the ropes onto the diverting pulley inside the casing is a difficult and time-consuming task. It is particularly difficult to mount the ropes on an encased diverting pulley when the ropes are passed around the encased diverting pulley in a structure where the grooves of the diverting pulley are at least partially hidden inside the casing. In such cases, the casing often has to be disassembled to allow the ropes to be mounted. This problem has a pronounced significance in new elevator solutions which, due to the rope suspension, comprise a plurality of diverting pulleys, with the result that the task of mounting the ropes in connection with first installation or rope change requires a very great deal of time.

Specification JP 2002-362851 discloses a solution in which the elevator hoisting ropes are pulled around the traction sheave by means of a pulling line, and this specification also describes attachment of the pulling line to the traction sheave, but it contains no description of clamping the ropes or their ends against a rope pulley by means of a rope holder.

The object of the present invention is to overcome the above-mentioned drawbacks and create a method enabling fast and reliable mounting of a rope and an easy-to-manufacture device economical in cost and enabling fast and reliable mounting of a rope for pulling ropes onto a rope pulley. The method of the invention is characterized by what is disclosed in the characterization part of claim 1. Correspondingly, the device of the invention is characterized by what is disclosed in the characterization part of claim 6. Other embodiments of the invention are characterized by what is disclosed in the other claims.

Inventive embodiments are also presented in the description part and drawings of the present application. The inventive content disclosed in the application can also be defined in other ways than is done in the claims below. The inventive content may also consist of several separate inventions, especially if the invention is considered in the light of explicit or implicit sub-tasks or in respect of advantages or sets of advantages achieved. In this case, some of the attributes contained in the claims below may be superfluous from the point of view of separate inventive concepts. Similarly, details presented in connection with each embodiment example of the invention can be applied in other embodiment examples as well.

Hereinafter, the method and device of the invention are referred to by the common designation ‘solution of the invention’. Moreover, the device alone is referred to hereinafter by the term ‘rope holder’, describing the manner of application of the device. The advantages of the solution of the invention include a simple, functional and maintenance-free rope holder structure and the fact that it allows the elevator ropes to be mounted quickly and reliably even in the case of a roping that comprises a plurality of diverting pulleys. In addition, the invention makes it possible to mount the ropes onto an encased rope pulley quickly and easily. A further advantage is that the rope holder makes it possible to mount the ropes onto the diverting pulley without opening the casing even when the ropes are passed around an encased diverting pulley in a structure where the grooves of the diverting pulley are at least partially hidden inside the casing. An additional advantage is that mutually adjacent ropes can easily be kept in good order during the mounting operation, so the ropes will not be tangled with each other.

In the following, the invention will be described in detail with reference to an embodiment example and the attached drawings, wherein

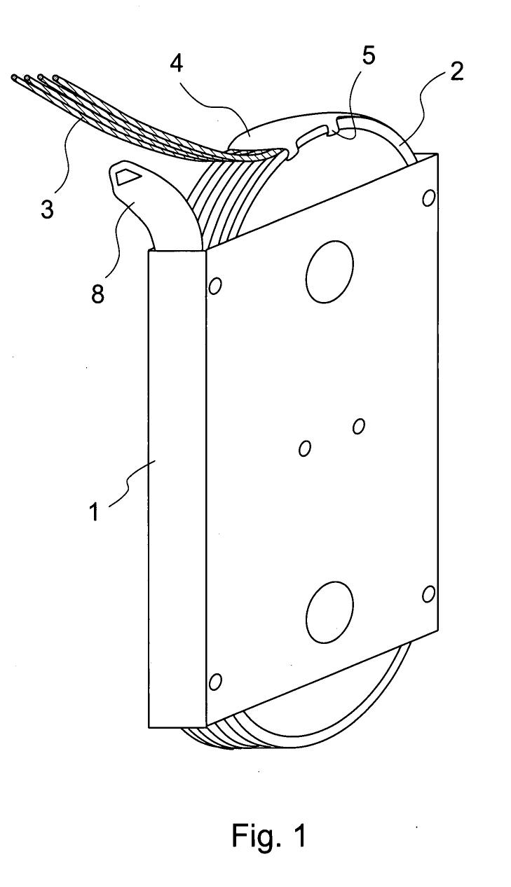

FIG. 1 presents an oblique top view of a rope holder according to the invention, attached to an encased diverting pulley,

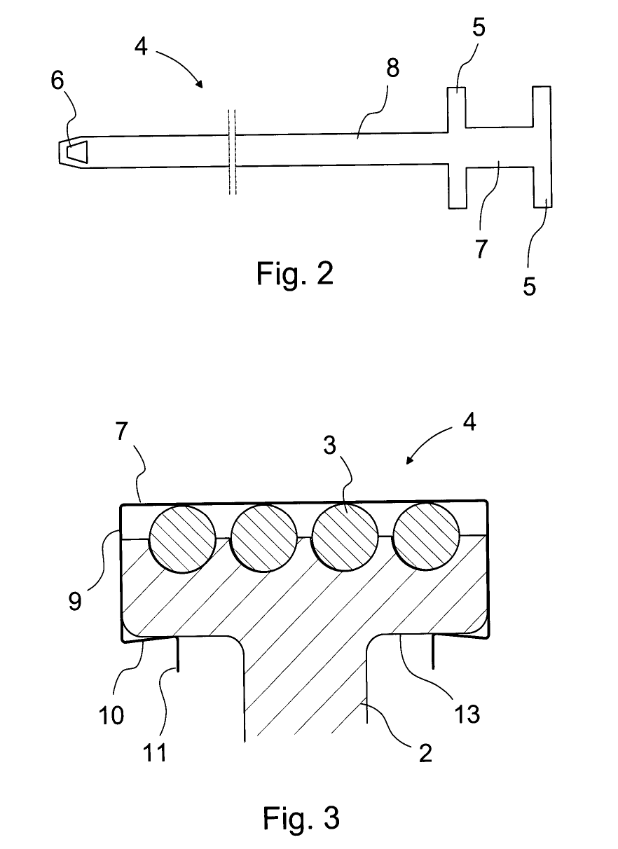

FIG. 2 presents a top view of the rope holder of the invention at the manufacturing stage in a shortened form,

FIG. 3 presents the rope holder of the invention attached onto a rope pulley in a sectional view from behind,

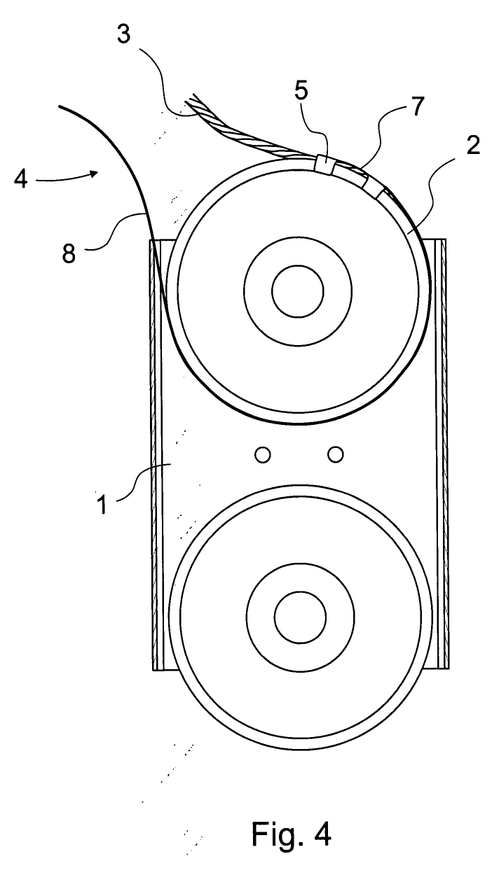

FIG. 4 presents a side view of the rope holder of the invention attached to an encased diverting pulley with the casing opened,

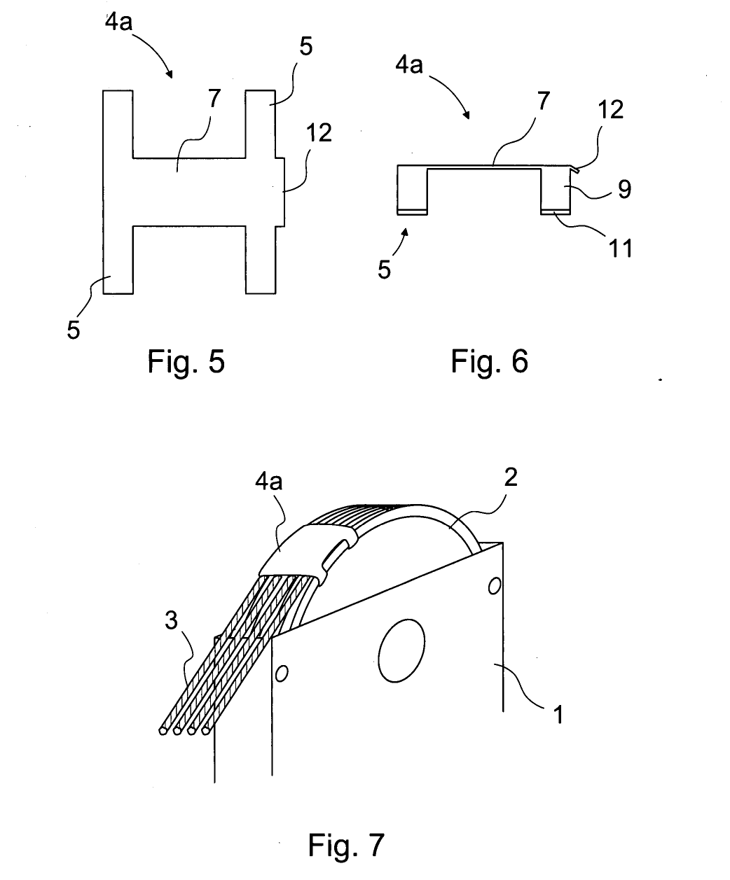

FIG. 5 presents a top view of a rope holder according to a preferred embodiment of the invention at the manufacturing stage,

FIG. 6 presents a side view of the rope holder of FIG. 5 in the finished form, and

FIG. 7 presents an oblique top view of the rope holder in FIGS. 5 and 6 attached to an encased diverting pulley.

FIG. 1 presents a diverting pulley casing 1 provided with two rope pulleys 2 functioning as diverting pulleys, placed one above the other. This type of casing structures are often used e.g. in elevators having a large suspension ratio, requiring many diverting pulleys. The rope holder of the invention can also be readily used in other casing solutions comprising only one or more diverting pulleys. The elevator hoisting ropes 3 running side by side are placed in the rope grooves on the upper rope pulley 2 so that the rope ends are clamped between the rope grooves and a flexible rope holder 4 fastened to the flange at the periphery of the rope pulley 2. The rope holder 4 is tightened against the inner surface of the flange of the rope pulley 2 by spring-like inwards-bent claws 5. Correspondingly, the stem part 8 of the rope holder 4 is bent over the rope pulley 2 along the outer surface of the rope pulley around the rope pulley 2 in such manner that, in FIG. 1, the leading end of the stem part 8 of the rope holder 4 projects suitably out over the forward upper edge of the casing 1. The bending of the rope holder 4 around the rope pulley 2 will be described in greater detail below in connection with the description of the method.

FIG. 2 presents the rope holder 4 of the invention at the manufacturing stage as a separate piece and shortened in its lengthwise direction and before the claws 5 are bent into their final shape. The strip-like rope holder 4 consists of a band-like and flexible material made of metal, e.g. steel, which has been so processed that the rope holder has a spring-like structure. At the trailing end of the rope holder 4 is a clamping part 7, which is a thin, substantially planar structure of rectangular form in the longitudinal direction of the rope holder. At the trailing end of the rope holder are two claws 5 projecting perpendicularly sideways from the clamping part 7, one claw on either side. Placed at a distance towards the leading end from the claws 5 at the trailing end are another two claws 5 corresponding to the aforesaid claws. Thus, there are a total of two substantially identical claws 5 on either side of the rope holder at the leading and trailing ends of the clamping part 7.

From the claws 5 towards the leading end, the rope holder has a strip-like, elongated, flexible stem part 8 extending as an even band-like structure towards the leading end of the rope holder, which leading end tapers forward in a wedge-like manner. The length of the stem part 8 is appropriately selected so that the total length of the stem part 8 and the clamping part 7 is substantially equal to or suitably greater than the length of the corresponding circumference of the rope pulley 2. The elongated stem part 8 makes it possible to thread the ropes around an encased rope pulley even when part of the rope pulley is hidden inside the casing. The hoisting ropes can therefore be easily and quickly mounted even on encased diverting pulleys to which the ropes come from above and, having passed around the diverting pulley, return upwards again, or similarly when the ropes come from below and, having passed around the diverting pulley, run downwards again. The leading end of the stem 8 of the rope holder 4 is additionally provided with an aperture 6 to allow the rope holder to be fastened to a pulling line, pulling tool or equivalent, by means of which the rope holder 4 is pulled around the rope pulley 2, simultaneously guiding the ropes 3 onto the rope pulley.

FIG. 3 presents the rope holder 4 of the invention, mounted on a rope pulley 2 and seen from the direction of the trailing end. To render the figure more illustrative, both the rope pulley 2 and the hoisting ropes 3 are shown in cross-section. At the manufacturing stage, the claws of the rope holder 4 are bent such that each claw 5 has a first deflection 9, which is bent substantially perpendicularly downwards from the side edge of the clamping part 7. Thus, both the width of the clamping part 7 and the distance between the opposite claws 5 substantially correspond to the width of the flange forming the outer rim of the rope pulley 2 for which the rope holder 4 is intended. On rope pulleys of different widths, it is preferable to use a rope holder designed for the rope pulley in question.

As an extension of deflection 9, the rope holder has a second deflection 10 bent inwards, i.e. towards the longitudinal center axis of the rope holder 4. The second deflection 10 has been bent suitably to an angle somewhat over 90° relative to the first deflection 9. Thus, the second deflection 10 is in a somewhat inclined position such that the tail of the second deflection 10 rises towards the clamping part 7. Similarly, the rope holder has a third deflection 11 forming an extension of the end portion of the second deflection 10 and bent suitably to an angle somewhat below 90° relative to the second deflection 10 so that the third deflection 11 and the first deflection 9 extend in substantially parallel directions, although this is not necessary.

The dimensions and positions of the deflections 9-11 of the rope holder intended for each rope pulley size have been adapted with respect to the dimensions of the rope pulley and the hoisting ropes 3 used, so that, when mounted on a rope pulley 2, the spring-like claws 5 with their deflections 9-11 produce a force pressing the hoisting ropes 3 into the rope grooves of the rope pulley 2. In this situation, the angle between the second deflection 10 and the third deflection 11 is touching the inner surface 13 of the flange forming the outer rim of the rope pulley 2 and pulls the clamping part 7 of the rope holder 4 towards the outer surface of the outer rim of the rope pulley. The clamping force is so selected that it is sufficient to keep the hoisting ropes 3 in the rope grooves by friction during the entire pulling movement, by which pulling movement the hoisting ropes 3 are guided over the rope pulley 2, simultaneously rotating the rope pulley. Thus, the bent claws 5 function as clamping and locking elements of the rope holder 4 and the ends of the ropes 3.

By the method of the invention, the ropes are mounted on a rope pulley by using a strip-like rope holder 4 as described above, e.g. as follows. First, the rope holder 4 is fastened without the ropes by its clamping part 7 to the flange of the rope pulley 2 by means of the claws 5. After this, the rope pulley 2 is rotated so that the rope holder 4 advances with the clamping part 7 first into the casing 1 and passes with the clamping part 7 first substantially around the rope pulley 2. In a case as illustrated in FIGS. 1 and 4, the rope pulley 2 is rotated anti-clockwise at this stage. The rope pulley 2 is rotated until the clamping part 7 of the rope holder 4, having passed around with the rope pulley, comes out of the casing 1 approximately to its starting point again. The length of the stem part 8 of the rope holder 4 is suitably dimensioned so that, when the clamping part 7 is again at about its starting point, the stem part 8 has not been drawn entirely into the casing 1, but the leading end of the stem part 8 remains visible outside the casing 1.

Next, the clamping part 7 is detached from the rope pulley either completely or only at its trailing end, and the ends of the ropes 3 are fitted into the grooves of the rope pulley 2 and pressed into position in the grooves by locking the clamping part 7 again by means of the claws 5 to the flange of the rope pulley 2 so that the ends of the ropes 3 remain at least under the clamping part 7. After the ends of the ropes 3 have thus been locked to the rope grooves of the rope pulley 2 by clamping, the ropes 3 are mounted on the rope pulley 2 by pulling the rope holder 4 by the leading end of the stem part 8 of the rope holder and guiding the ropes 3 to pass over the rope pulley. If the rope pulley 2 does not readily rotate by itself during the pulling, the movement of the ropes 3 into position is additionally assisted if necessary by rotating the rope pulley 2 and simultaneously feeding the ropes 3 onto the rope pulley 2 as loosely as possible. The rope holder 4 protects the rope ends and guides the ropes along the grooves of the rope pulley around the rope pulley 2, and thus the jump guards placed in the casing near the outer rim of the rope pulley 2 are not an obstacle to the installation of the ropes. The jump guards are omitted from the drawings for the sake of clarity.

FIG. 5-7 present a short rope holder 4a according to a preferred embodiment of the invention for the mounting of ropes 3 on a rope pulley. A difference to the structure of the strip-like rope holder 4 mentioned above is that the rope holder 4a has no long, strip-like stem part 8. The structure, dimensions and function of the clamping part 7 together with the spring-like claws 5 are substantially identical to those of the strip-like rope holder 4 described above. Instead of an elongated stem part 8, the clamping part 7 has at its forward edge a substantially short projection 12 bent obliquely downwards, pointing in an obliquely downward and forward direction and having a width substantially equal to that of the clamping part 7. One of the functions of the projection 12 is to prevent the ends of the ropes 3 from coming out from under the forward edge of the clamping part 7 when the ropes are being pushed forwards. Thus, the ends of the ropes 3 can neither slide forwards nor bend freely away from the groove, in which case they might e.g. hit the jump guards inside the casing 1 or cause other problems. Alternatively, the edge of the rope holder can also be bent downwards to form a short bevel even if it has no projection 12.

By the method of the invention, the ropes are mounted on a rope pulley by using a short rope holder 4a e.g. as follows. First, the ends of the ropes 3 are fitted into the groove of the rope pulley 2 and pressed into position by locking the clamping part 7 to the flange of the rope pulley 2 by means of the claws 5 so that the ends of the ropes 3 remain under the clamping part 7. After the ends of the ropes 3 have thus been locked to the rope grooves of the rope pulley 2 by clamping, the ropes 3 are mounted on the rope pulley 2 by suitably pushing the ropes 3 in their direction of advance and guiding the ropes 3 to pass around the rope pulley. The movement of the ropes 3 into position is additionally assisted if necessary by rotating the rope pulley 2 and simultaneously feeding the ropes 3 onto the rope pulley 2 in a suitable manner. The rope holder 4a protects the rope ends and guides the ropes along the grooves of the rope pulley around the rope pulley 2, and thus the jump guards in the casing near the outer rim of the rope pulley 2 are not an obstacle to the installation of the ropes.

It is obvious to the person skilled in the art that the invention is not limited to the example described above, but that it may be varied within the scope of the claims presented below. Thus, the shape and material of the rope holder may differ from those described above. The rope holder may be made partly or completely from a material other than band-like steel. For example, the stem part 8 may be made of plastic or a corresponding material while the clamping part 7 and claws 5 are of spring-like metal. The stem part 8 may also be a threadlike or soft band-like part.

It is additionally obvious to the skilled person that the clamping effect produced by the clamping part 7 and claws 5 can also be accomplished by using a different type of structure instead of a structure based on spring force. One expedient to solve the matter is to use e.g. tightening screws, eccentric elements or other corresponding structures to press the clamping part 7 against the ropes 3 and the outer surface of the rope pulley 2.

1. A method for mounting a rope on a rope pulley by winding the rope at least partially around the rope pulley, wherein the end of the rope to be mounted is pressed into a rope groove of the rope pulley by means of a special rope holder attachable to the rope pulley, and that the rope is guided over the rope pulley by setting the rope pulley into rotating motion.

2. A method according to claim 1, wherein a clamping part comprised in the rope holder is pressed onto the end of one or more mutually adjacent ropes and locked to the inner surface of a flange forming the outer rim of the rope pulley to produce a clamping effect on the ropes.

3. A method according to claim 1, wherein the ropes pressed by their ends into the grooves of the rope pulley by means of the rope holder are mounted in the grooves of the traction sheave by pushing the ropes in the direction of advance around the rope pulley by setting the rope pulley into rotating motion by the action of the pushing movement and/or by rotating the rope pulley

4. A method according to claim 1, wherein first the rope holder is fastened without the ropes by its clamping part to the flange of the rope pulley by means of claws, whereupon the rope pulley is rotated so that the rope holder advances with the clamping part first around the rope pulley substantially approximately to its starting point so that the leading end of the stem part remains visible outside the casing, whereupon the clamping part is detached from the rope pulley, the ends of the ropes are fitted into the grooves of the rope pulley and pressed into position in the grooves by locking the clamping part again by means of the claws to the flange of the rope pulley and the ropes are mounted on the rope pulley by rotating the rope pulley by pulling by the leading end of the stem part of the rope holder and guiding the ropes to pass over the rope pulley.

5. A method according to claim 1, wherein the ends of the ropes to be mounted are clamped by means of the rope holder against the rope grooves of the rope pulley by spring force.

6. A device for mounting a rope on a rope pulley by passing the rope at least partially around the rope pulley, wherein the device consists of at least a rope holder, said rope holder comprising at least a clamping part that presses one or more mutually adjacent ropes against the rope pulley and that is attachable to the rope pulley.

7. A device according to claim 6, wherein the clamping part of the rope holder comprises at least claws functioning as clamping elements and producing a spring force, said claws being provided with deflections.

8. A device according to claim 6, wherein the claws have been so designed and bent that, when the rope holder has been set in position upon the ends of the ropes during the mounting of the ropes, the claws can be locked by at least one of their deflections to the inner surface of the flange forming the outer rim of the rope pulley.

9. A device according to claim 6, wherein the width of the clamping part of the rope holder is substantially the same as the width of the outer rim of the rope pulley for which the rope holder is intended.

10. A device according to claim 6, wherein the device comprises an elongated, flexible stem part, said stem part having at its leading end a hole for the attachment of the rope holder to a pulling line, pulling tool or equivalent.

11. A device according to claim 6, wherein the clamping part of the rope holder has at its edge a substantially short projection or bevel having a width substantially equal to that of the clamping part and bent obliquely downwards.

12. A device according to claim 6, wherein the clamping part of the rope holder has at its forward edge a substantially short projection having a width substantially equal to that of the clamping part and bent obliquely downwards.
